(19) United States
(12) Patent Application Publication
(10) Pub. No.: US 2024/0070775 A1
(43) Pub. Date: Feb. 29, 2024

(54) TRADING MATRIX

(71) Applicant: Wells Fargo Bank, N.A., San Francisco, CA (US)

(72) Inventors: Serhan Altunata, Jersey City, NJ (US); Mikhail Faktorovich, New York, NY (US); Eduardo Gonzalez, Mt. Kisco, NY (US); Peter William Haas, Hoboken, NJ (US); Sam Li, Great Neck, NY (US)

(21) Appl. No.: 17/219,089

(22) Filed: Mar. 31, 2021

(51) Int. Cl. G06Q 40/04; G06N 20/00; G06Q 30/02

(52) U.S. Cl. CPC G06Q 40/04; G06N 20/00; G06Q 30/0202

(57) ABSTRACT

In equities trading, users typically develop trading strategies designed to achieve profitable returns. The trading strategies may include rules surrounding how to respond to particular market conditions. However, when a wide variety of conflicting market scenarios arise, users are often confused and unsure of how to untangle all the conflicting market conditions and struggle with making a final trading decision. The disclosed trade execution engine uses a switching matrix model to separate the different market conditions and reacts to the different market states based on intelligent execution driving signals.

### BACKGROUND

Electronic trading platforms can be used to place orders for financial products over a network with a financial intermediary. Financial products that can be purchased through the electronic trading system includes stocks, bonds, currencies, commodities, etc. Unlike traditional floor trading, the electronic trading platform allows traders and/or entities to place electronic trades from any location for such financial products with financial intermediaries, such as stock exchanges, banks, etc.

These trading platforms can be used to accomplish various trading strategies, including trade entries, exits and money management that may then be used to carry on trades automatically when certain criteria outlined in the submitted rules are met. The platforms can offer many advantages such as minimizing emotions, testing the viability of the strategy using historical data, preserving discipline, etc.

### SUMMARY

Embodiments of the disclosure are directed to a trade execution system that uses a switching matrix model that reconciles a plurality of trading strategy algorithms to execute users' trade orders.

In a first embodiment, a method for executing trade instructions from a user is disclosed. The method comprises: receiving a plurality of input parameters, wherein: at least one of the plurality of input parameters is associated with market conditions; and at least one of the plurality of input parameters is associated with parameters that define the trade instructions from the user; generating one or more matrices, with each of the matrices including a plurality of nodes, wherein each of the plurality of nodes represents a market state and associated execution strategy; based on the plurality of input parameters, defining one or more signals, wherein each of the signals represents an aspect of a predicted market state; based on the one or more signals, selecting a first node of one of the matrices that represents the predicted market state; and causing the execution of an execution strategy associated with the first node.

In a second embodiment, a system for executing trade instructions from a user is disclosed. The system comprises: a processor; memory comprising instructions that when executed by the process causes the processor to: receive a plurality of input parameters, wherein: at least one of the plurality of input parameters is associated with market conditions; and at least one of the plurality of input parameters is associated with parameters that define the trade instructions from the user; generate one or more matrices, with each of the matrices including a plurality of nodes, wherein each of the plurality of nodes represents a market state and associated execution strategy; based on the plurality of input parameters, define one or more signals, wherein each of the signals represents an aspect of a predicted market state; based on the one or more signals, select a first node of one of the matrices that represents the predicted market state; and cause the execution of an execution strategy associated with the first node.

In a third embodiment, a method for executing trade instructions from a user is disclosed. The method comprises: receiving a plurality of input parameters, wherein: at least one of the plurality of input parameters is associated with market conditions; and at least one of the plurality of input parameters is associated with parameters that define the trade instructions from the user; analyzing the trade instructions from the user; determining a plurality of execution phases to the trade instructions including a first execution phase and a second execution phase, wherein each of the plurality of execution phases requires different execution strategies; generating a matrix stage for each execution phase of the plurality of execution phases, including a first matrix stage associated with the first execution phase and a second matrix stage associated with the second execution phase; for each matrix stage, generating a matrix with a plurality of nodes, wherein each of the plurality of nodes represents a market state and associated execution strategy; executing the plurality of execution phases, including: for the first execution phase, based on the plurality of input parameters, defining a first plurality of signals, wherein each of the first plurality of signals represents an aspect of a first predicted market state; based on the first plurality of signals, selecting a first node of a matrix from the first matrix stage that represents the first predicted market state; and causing the execution of an execution strategy associated with the first node; and for the second execution phase, receiving updated plurality of input parameters, including updated market conditions; based on the updated plurality of input parameters, defining a second plurality of signals, wherein each of the second plurality of signals represents an aspect of a second predicted market state; based on the second plurality of signals, selecting a second node of a matrix from the second matrix stage that represents the second predicted market state; and causing the execution of an execution strategy associated with the second node.

The details of one or more techniques are set forth in the accompanying drawings and the description below. Other features, objects, and advantages of these techniques will be apparent from the description, drawings, and claims.

### BRIEF DESCRIPTION OF DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an example configuration of a trade execution system.

FIG. 2 illustrates an example configuration of a trade execution engine of the system of FIG. 1.

FIG. 3 illustrates an example configuration of the trade execution analysis module associated with the trade execution engine of FIG. 2.

FIG. 4 illustrates an example configuration of one of the one or more matrices of the switching matrix model associated with the trade execution engine of FIG. 2.

FIG. 5 illustrates example physical components of the computing devices of FIG. 1.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

In general, the subject matter of the present disclosure relates to a trade execution engine that helps users evaluate different market conditions and make final trading decisions. For example, the disclosed trade execution engine includes a qualitative switching matrix model that is configured to behave as a ‘switchboard’ between different trade-order execution algorithms for orders placed by users.

In equities trading, users typically develop trading strategies designed to achieve profitable returns. The trading strategies may include rules surrounding how to respond to particular market conditions. However, when a wide variety of conflicting market scenarios arise, users are often confused and unsure of how to untangle all the conflicting market conditions and struggle with making a final trading decision. The disclosed trade execution engine uses a switching matrix model to separate the different market conditions and reacts to the different market states based on intelligent execution driving signals.

In some examples, the disclosed switching matrix model is used as a trade execution strategy. The switching matrix model encompasses a plurality of different trading algorithms. The trading algorithms are sets of rules implemented within the trade execution engine. For example, the rules may be set based on empirical observations and can be set in consultation with the users. The users have substantial experience in executing buy/sell orders. The users also observe the execution outcomes of the model in real time and have tools to tweak or outright cancel the execution and either manually take over or replace it with the updated trading algorithm parameters.

In some examples, the users, can configure the trading strategy parameters via one or more options on a user interface screen associated with the electronic trade execution engine. The input strategy parameters are used by the switching matrix model to configure and output a trading strategy.

In some examples, the switching matrix model is configured using one or more matrices. A matrix may include a two-dimensional array of nodes. In some examples, each node represents a market state, wherein, each node drives a different execution action. The one or more matrices and the nodes that define the matrix are configured automatically using pre-defined algorithms, machine learning models or the users themselves through one or more settings available through a user interface associated with the trade execution engine. For example, the nodes themselves may be defined based on volume of trades that day, volatility in the market, or other such market states. Each node includes configuration parameters that define execution instructions. When the execution training model lands on a particular node, the configure execution instructions associated with the particular node are executed.

In some examples, one or more execution driving signals drive the switching matrix model to move between the different nodes within a matrix. The one or more execution driving signals together define the market condition. In some examples, the market condition can be abstracted out and a machine learning model can be used to predict different aspects of the market condition. The one or more execution driving signals drive the switching matrix model to move between the different nodes within a matrix.

In the disclosed trade execution system, the execution driving signals can be agnostic. In other words, the execution driving signals need not be defined in a particular manner. Rather, the execution driving signals are abstracted and serve as input parameters that define the market state to the switching matrix model. For example, in the disclosed system, the underlying manner in which the execution driving signals are defined is agnostic. A machine learning model, a pre-defined algorithm or input from a user may be used to define the execution driving signals. When conditions in the market shifts, the underlying machine learning model or pre-defined algorithm used to define the execution driving signals can be quickly altered without having to alter the switching matrix model itself. Thus, the disclosed system can react to shifts in market conditions quickly and efficiently in a way that may not be possible with typical trade execution systems.

In some examples, the switching matrix model also receives feedback over changes in the market condition and the effects of the execution instructions as inputs that are then used by a machine learning model that translates the market conditions into the execution driving signals that further drive the execution model to the appropriate node within a matrix.

In some examples, the switching matrix model may switch between the plurality of matrices based on configured conditions related to the matrices. For example, the plurality of matrices may be configured as different stages within the execution model that the switching matrix model may switch between. The different matrix stages may include nodes with different configurations and execution instructions. For example, in a switching matrix model that is implemented with three matrix stages, where the model may switch to the next stage upon completion of 33% of the trade order, each stage may include

In one example, the switching matrix model may include three matrix stages. The switching matrix model may switch from the first stage to the second stage and from the second stage to the third stage upon completion of conditions associated with each matrix stage. For example, a condition could include switching stages after completion of 33% of a trade order. In such a case, the nodes within each matrix stage may include configurations and execution instructions that are influenced by the percentage of the trade order that is completed. In some cases, the configurations and conditions associated with the switching of the matrices may be automatically set by a pre-determined algorithm, machine learning models and/or the user itself.

The trading strategy output from the switching matrix model may be used by the trade execution engine to place and execute one or more trades. For example, the one or more trades may be represented by one or more child trading orders that are then executed by the trade execution engine.

In some examples, based on live market conditions and current order status, the trading strategy may be continually updated during the execution of the child trade orders. For example, if market conditions vary enough that a change in trading strategy is warranted, then based on the current order status (i.e., the portion of the order that is already filled), the child trading order may be modified or canceled for the portion of the order that is yet to be filled.

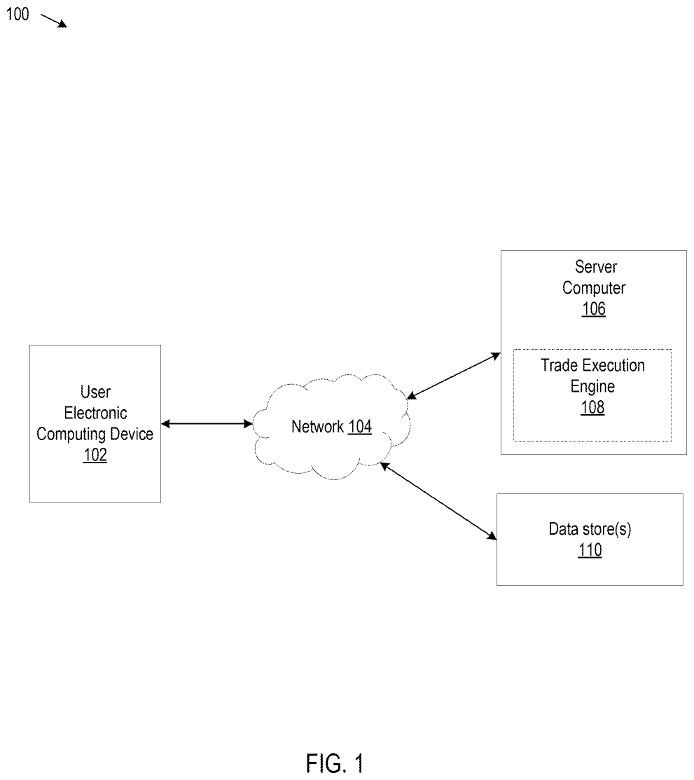

FIG. 1 illustrates an example configuration of a trade execution system 100. The system 100 includes a user electronic computing device 102, a network 104, a server computer 106 and one or more datastores 110. In some examples, the server computer 106 may include a trade execution engine 108. More, fewer, or different modules can be used.

In some examples, user electronic computing device 102 is an electronic computing device of the user. In some examples, the electronic computing device can be a desktop computer, a laptop computer, virtual reality user device, a mobile electronic computing device such as a smartphone or a tablet computer. The electronic computing device permits the user to access the server computer 106 over a network 104. In some examples, the user may be an individual or an entity that engages in trading of financial products such as stocks. Although a single user electronic computing device 102 is shown, the system 100 allows hundreds, thousands, or more computing devices to connect to the server computer 106.

In some examples, the network 104 is a computer network, such as the Internet. The user on user electronic computing device 102 can access the financial institution server computer 106 via the network 104.

In a preferred example, the server computer 106 is a server computer of a financial institution, such as a bank or a server computer of an entity providing service related to trading of financial products. Although a single server is shown, in reality, the server computer 106 can be implemented with multiple computing devices, such as a server farm or through cloud computing. Many other configurations are possible.

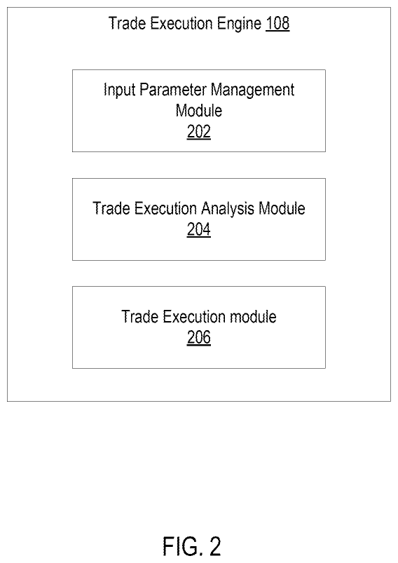

In one example, the trade execution engine 108 is configured to receive input configuration and preference information, analyze the input information using a switching matrix model that is trade strategy algorithm agnostic and issue trade execution orders based on the analysis from the switching matrix model. The implementation of the trade execution engine 108 is described in further detail in relation FIG. 2-5.

The example datastore 110 may include one or more electronic databases that can store data related to the user and/or trade execution engine 108. The datastore 110 may be maintained by the same entity that maintains the server computer 106 or one or more external enterprises associated with the entity that maintains the server computer 106. The datastore 110 can be accessed by server computer 106 to retrieve relevant data associated with the user and the trade execution engine 108.

FIG. 2 illustrates an example configuration of the trade execution engine 108 of FIG. 1. In some examples, the example trade execution engine 108 may be configured to include an input parameter management module 202, a trade execution analysis module 204 and a trade execution module 206.

In some examples, the input parameter management module 202 is configured to receive a plurality of input configurations that are then used by the trade execution analysis module 204 to generate one or more trade execution orders. For example, the plurality of input configurations relate to the market conditions and are received from a variety of sources in order of the trade execution analysis module 204 to make appropriate determinations regarding execution instructions corresponding to the market conditions. For example, the plurality of input configurations may include trade parameters, financial product characteristics, and financial product trends. In other examples, other input configurations are also possible.

In some examples, the trade parameters may include parameters that are received from the user through a user interface associated with the trade execution engine 108. Example trade parameters include, but are not limited to, execution time, size of the trade order, order type, limit, price, and strategy. In some examples, the user interface may include a list of parameters associated with making trades that may initially be set to default values that are then changeable by the user if the user so desires. For example, the user may choose to change the default values of a subset of the trade parameters associated with trades execution engine 108. In such a case, the trade parameters customized by the user retain the values selected by the user, while the rest of the trade parameters retain the default values.

In some examples, the default values of the one or more trade parameters may be based on determinations from a pre-defined algorithm. In other examples, the default values of the one or more trade parameters may be based on determinations from a machine learning model. For example, the machine learning model may learn from past user selections or past trade performance and may determine the values for one or more of the trade parameters. Other ways of setting the default values for the trade parameters is also possible.

In some examples, the financial product characteristics may include features associated with each financial product in the tradeable universe or at least a substantial subset of financial products in the tradeable universe. Some examples of financial product characteristics include . . . . The features associated with a financial product may be acquired from a third-party entity or may be extracted by performing analytics on a financial product. In some examples, the financial product characteristics may be stored in a JavaScript Object Notation (JSON) file. In other examples, the financial product characteristics may also be stored in other formats.

In some examples, the plurality of input configuration may include one or more files contains trends related to a plurality of financial products, such as stocks. In some examples, the trends may include curves related to features related to each or a subset of the financial products traded over a period of time. Other types of trends related to the plurality of financial products may also be included in a file that is included as an input configuration.

In some examples, the input parameter management module 202 receives the plurality of input configurations from one or more sources. The received plurality of input configurations may then be fed into the trade execution analysis module 204 for analysis.

In some examples, the trade execution analysis module 204 may be configured to implement a switching matrix model that includes one or more matrices. Each of the one or more matrices may be configured with one or more nodes that are each configured with execution instructions. Depending on the trends of the execution driving signals, the appropriate node and associated execution instructions are sent to the trade execution module 206 for execution.

For example, the trade execution analysis module 204 may analyze the plurality of input parameters received from the input parameter management module 202 and configure one or more execution driving signals based on the input parameters. The execution driving signals are abstracted from the input parameters to define the market conditions. The execution driving signals may be used to drive the switching matrix model to determine the node corresponding to the determined market state and the appropriate execution instructions associated with the determined node are sent to the trade execution module 206 for execution.

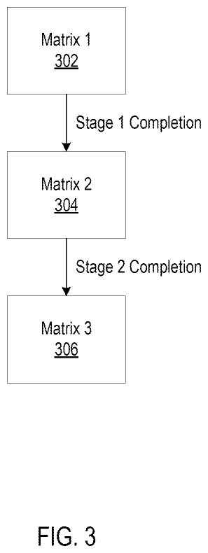

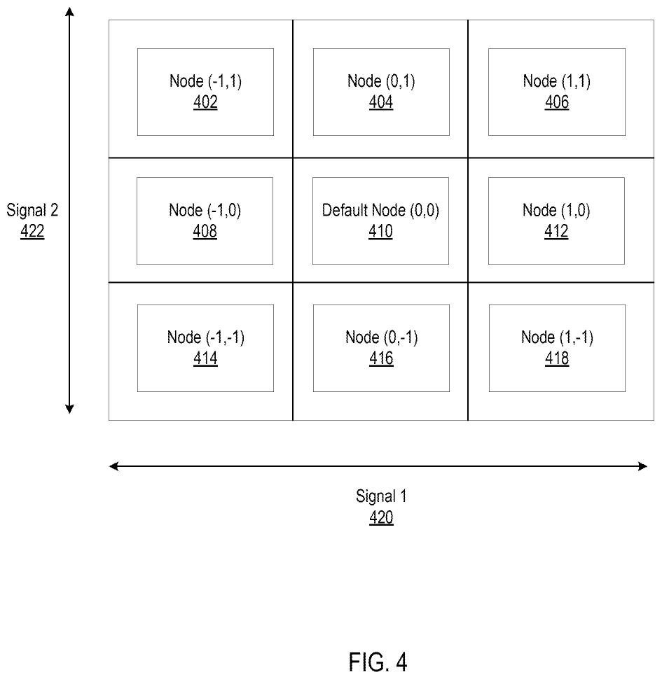

The configuration and implementation of the trade execution analysis module 204 are described in greater detail in association with FIG. 3-4.

In some examples, the trade execution module 206 may be configured to implement the trading strategy determined by the trade execution analysis module 204 by executing the execution instructions received from the execution analysis module 204.

For example, the trade execution module 206, upon receiving instructions to execute trade orders, may break up the trading orders into one or more child orders. The determination of splitting a trade order into a plurality of child orders may depend on the complexity and time frame of the trade order itself. For example, a trade execution order to buy a thousand shares of a stock in the next minute may spawn a single child order. However, a trade execution order to buy 100,000 shares of a stock over the next 10 minutes may spawn a plurality of child orders. In one example, the trade execution order to buy 10,000 shared of a stock over the next 10 minutes may spawn 10 child orders, each corresponding to buying 1000 shares within the required time span. Other ways of splitting the parent order into child orders are also possible.

In some examples, once the child orders associated with the trade execution orders are determined, the child orders may be sent to execution venues where the actual execution of the child orders are completed. In some examples, the market conditions and the response to the child orders are carefully monitored and the changes and responses from the market are collected and sent to the input parameter management module 202, in a feedback loop configuration, to provide further insight into the market conditions. The feedback regarding the market conditions are used by the trade execution analysis module 204 to further tune the execution driving signals that drive the switching matrix model to select the node and execution instructions associated with the user's trade order.

FIG. 3 illustrates an example configuration of the trade execution analysis module 204 from FIG. 2. In some examples, the trade execution analysis module may implement a switching matrix model that includes one or more stages of matrices, each with a plurality of nodes that are each associated with an execution strategy.

In some examples, a matrix may include a two-dimensional array of nodes. For example, a node may be a representation of a market state. Each node is associated with different execution strategies based on the market state that the node represents. For example, an execution strategy may be configured by setting one or more parameters associated with the execution strategy. For example, if the market state represented by a node is associated with low market volatility condition, the associated execution strategy may include setting the execution aggression level parameter to high. In some examples, nodes within a matrix may reference the same execution strategy with the same strategy settings. In other examples, different nodes may also reference the same execution strategy but with different settings.

For example, parameters associated with execution strategies may include one or more of: start time offset, end time offset, execution aggression level, trade volume participation target, minimum amount to be executed in dark venues, minimum quote size, scaling type, force complete, sweep options (e.g. sweep until set price is reached, sweep o an offset from current average price, etc.), order quantity, order price, and order offset. Other examples of execution strategies are also possible.

In some examples, the one or more matrix stages and the nodes that define the matrix are configured automatically using pre-defined algorithms, machine learning models or the users themselves through one or more settings available through a user interface associated with the trade execution engine 108. The selection of a node based on market conditions and the execution on trade instructions based on the execution strategy associated with that node are described in greater detail in relation to FIG. 4.

In the disclosed example, the switching matrix model of the trade execution analysis module 204 is implemented with three stages of matrices, a first matrix stage 302, a second matrix stage 304 and a third matrix stage 306. In other examples, the switching matrix model of the trade execution analysis module 204 may be implemented with more or fewer stages of matrices. In some examples, the number of stages of matrices configured in a switching matrix model depends on the input parameter configurations that may be set by the user or pre-defined algorithms and/or machine learning models.

In some examples, the implementation of the switching matrix model using multiple stages of matrices allows greater customization of execution of trades. For example, the switching matrix model may switch from the first stage to the second stage and from the second stage to the third stage upon completion of conditions associated with each matrix stage. For example, a condition could include completion of 33% of a trade order. In such a case, once 33% of the trade orders are completed, the switching matrix model may consider the first matrix stage 302 completed and move to the second matrix stage 304. After 66% of the trade orders are completed, the trade execution may consider the second matrix stage 304 completed and move to third matrix stage 306.

In some examples, each stage of the matrix may include different execution strategies for similar market states as the stages take into account the progress of the trader order or other conditions associated with completing the stages. In the above example, the nodes within each matrix stage may include configurations and execution instructions that are influenced by the percentage of the trade order that is completed.

For example, if the user's instructions are to buy 3000 shares of IBM, and if there were three stages were completion of a stage was defined as completing 33% of the trade order, then during the first stage, the execution strategy would be to buy 1000 shares of IBM at each stage. However, each stage of the matrix may include different execution strategy for purchasing the 1000 shares of IBM, even for the same or similar market states.

For example, for a particular market state represented by a first node in the first matrix stage 302, the execution instructions may include a faster time span for executing the trade order to buy 1000 shares of IBM than a second stage where the time span may be slightly more relaxed for the same or similar market states. In other words, during the first stage, the switching matrix model may settle on a first node that represents a market state that may include execution instructions to purchase 1000 shares of IBM within 2 seconds. Upon completion of the purchase, the switching matrix model would consider the first stage completed and move on to the second stage where the switching matrix model may settle on a second node that may represent a similar market states as the first node, but include execution instructions to purchase 1000 shares of IBM within 10 seconds.

In some examples, the splitting of the matrices into a plurality of stages, where each stage includes an array of nodes, each associated with execution strategies tailored to the market state represented by the node gives the trade execution engine 108 greater control and granularity for conducting trade executions. In some cases, the configurations and conditions associated with the switching of the matrices may be automatically set by a pre-determined algorithm, machine learning models and/or the user itself through the user interface associated with the trade execution engine 108.

FIG. 4 illustrates an example configuration of one of the one or more matrices of the switching matrix model implemented by the trade execution analysis module 204. As described in relation to FIG. 3 above, each stage of a matrix includes an array of nodes, where each node corresponds to a market state and each market state is associated with the appropriate trade strategy that would maximize gains for the particular market state.

The disclosed example from FIG. 4 illustrates a single matrix stage of the switching matrix model, configured to include a two-dimensional 3×3 array of nodes 402-418. In other examples, the size and dimension of the array may vary. In addition to the 3×3 array of nodes 402-418, the matrix also includes two execution driving signals, signal 1 420 and signal 2 422, corresponding to the two dimensions of the disclosed 3×3 matrix. In other examples where the matrix may include more dimensions, a greater number of execution driving signals may be included. The execution driving signals may be used to drive the switching matrix model to settle on a node that aligns with the predicted market state.

In some examples, the one or more execution driving signals, together, determine the overall market state or the response from the market to trade executions. The market state itself may be captured as one of the input parameters by the input parameter management module 202 and the captured overall market state may be abstracted into a plurality of execution driving signals that define different aspects of the market state.

Example market parameters that can be used in calculating execution driving signals include: order current price impact on market price, node current impact on market price, stock price return from day's open to order arrival time, stock price return from day's open to current node activation time, order momentum in volatility units and node momentum in volatility units. Other types of market parameters may also be used in calculating the execution driving signals.

In the disclosed example, each of the execution driving signals 420, 422, represent an aspect of the predicted market state. The execution driving signals 420, 422 drive the switching matrix model to move between the nodes 402-418. For example, each of the nodes 420, 422 includes an upper threshold and a lower threshold for market parameters.

For example, initially, the switching matrix model may start at a default node 410 that is indicated by the node value (0,0). The default node may be selected based on a pre-defined algorithm or a machine learning model that predicts the default node based on past user selections and trade executions. Based on the predicted market state, the execution driving signals, signal 1 420 and signal 2 422 may drive the switching matrix model to move from the default node 410.

For example, if the signal 1 420, based on the predicted market state, exceeds the upper threshold of the default node 410 for a market parameter associated with signal 1 420, then the switching matrix model may move from the default node 410 in a positive x-axis direction and land on node 412 that is represented by the node value (1,0). Similarly, if the signal 1 420, based on the predicted market state, falls lower than the lower threshold of the default node 410 for a market parameter associated with signal 1 420, then the switching matrix mode may move from the default node 410 in a negative x-axis direction and land on node 408 that is represented by the node value (−1,0).

Similar to the movement of the switching matrix model in the positive and negative x-axis direction, if the signal 2 422 exceeds the upper threshold of the default node 410 for a market parameter associated with signal 2 422, then the switching matric model may move from the default node 410 in a positive y-axis direction and land on node 404 that is represented by the node value (0,1) and if the signal 2 422 falls lower than the lower threshold of he default node 410 for a market parameter associated with signal 2 422, then the switching matrix model may move from the default node 410 in a negative y-axis direction and land on node 416 that is represented by the node value (0,−1).

In some examples, the switching matrix model may land on a node within the matrix stage that best represents the market state according to the values of the one or more execution driving signals. In turn the execution strategy and/or instructions associated with node that the switching matrix model lands is sent to the trade execution module 206. The execution of the strategy or instructions itself is described in further in relation to the trade execution model 206.

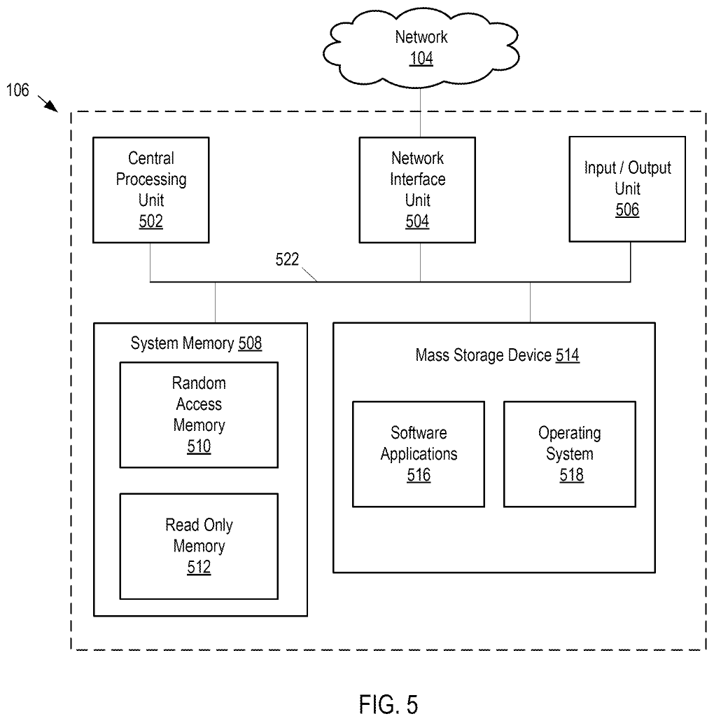

FIG. 5 illustrates example physical components of the computing devices of FIG. 1. As illustrated in the example of FIG. 5, the server computer 106 includes at least one central processing unit (“CPU”) 502, a system memory 508, and a system bus 522 that couples the system memory 508 to the CPU 502. The system memory 508 includes a random-access memory (“RAM”) 510 and a read-only memory (“ROM”) 512. A basic input/output system that contains the basic routines that help to transfer information between elements within the server computer 106, such as during startup, is stored in the ROM 512. The server computer 106 further includes a mass storage device 514. The mass storage device 514 is able to store software instructions and data 516 associated with software applications 516. Some or all of the components of the server computer 106 can also be included in user electronic computing device 102.

The mass storage device 514 is connected to the CPU 502 through a mass storage controller (not shown) connected to the system bus 522. The mass storage device 514 and its associated computer-readable data storage media provide non-volatile, non-transitory storage for the server computer 106. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central processing unit can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server computer 106.

According to various embodiments of the invention, the server computer 106 may operate in a networked environment using logical connections to remote network devices through the network 104, such as a wireless network, the Internet, or another type of network. The server computer 106 may connect to the network 104 through a network interface unit 504 connected to the system bus 522. It should be appreciated that the network interface unit 504 may also be utilized to connect to other types of networks and remote computing systems. The server computer 106 also includes an input/output controller 506 for receiving and processing input from a number of other devices, including a touch user interface display screen, or another type of input device. Similarly, the input/output controller 506 may provide output to a touch user interface display screen or other type of output device.

As mentioned briefly above, the mass storage device 514 and the RAM 510 of the server computer 106 can store software instructions and data associated with software applications 516. The software instructions include an operating system 518 suitable for controlling the operation of the server computer 106. The mass storage device 514 and/or the RAM 510 also store software instructions, that when executed by the CPU 502, cause the server computer 106 to provide the functionality of the server computer 106 discussed in this document. For example, the mass storage device 514 and/or the RAM 510 can store software instructions that, when executed by the CPU 502, cause the server computer 106 to display received data on the display screen of the server computer 106.

Although various embodiments are described herein, those of ordinary skill in the art will understand that many modifications may be made thereto within the scope of the present disclosure. Accordingly, it is not intended that the scope of the disclosure in any way be limited by the examples provided.

1. A computer-implemented method for executing trade instructions from a user, the computer-implemented method being executed on a processor of a computing device and comprising:
receiving a plurality of input parameters, wherein:
at least one of the plurality of input parameters is associated with market conditions; and
at least one of the plurality of input parameters is associated with parameters that define the trade instructions from the user;
generating one or more matrices, with each of the matrices including a plurality of nodes, wherein each node of the plurality of nodes represents a market state and includes an associated execution strategy based on the market state that each node represents;
using a machine learning model, predicting future market conditions;
based on the plurality of input parameters and the future market conditions predicted by the machine learning model, defining one or more execution signals, wherein each of the one or more execution signals represents an aspect of a predicted market state;
based on the one or more execution signals, selecting a first node of one of the matrices that represents the predicted market state;
causing the execution of an execution strategy associated with the first node;
receiving changes in market conditions as a result of the execution of the execution strategy associated with the first node;
using the machine learning model, predicting updated future market conditions;
based on the changes in the market conditions and the updated future market conditions, defining one or more updated execution signals such that the one or more updated execution signals represent an aspect of a modified predicted market state;
selecting a second node that represents the modified predicted market state; and
causing the execution of an updated execution strategy associated with the second node.

2. (canceled)

3. The method of claim 1, further comprising:
analyzing the trade instructions from the user;
determining a plurality of execution phases to the trade instructions, wherein at least two of the plurality of execution phases require differing execution strategies; and
generating a matrix stage for each execution phase of the plurality of execution phases.

4. The method of claim 3, wherein generating one or more matrices includes generating a matrix with a plurality of nodes for each matrix stage.

5. The method of claim 4, wherein, upon completion of one of the plurality of execution phases, switching to the execution of another of the plurality of execution phases.

6. The method of claim 5, wherein the completion of one of the plurality of execution phases includes:
selecting a node within a matrix in the matrix stage associated with the execution phase; and
causing the execution of an execution strategy associated with the node.

7. The method of claim 1, wherein the plurality of input parameter further includes financial product characteristics, and financial product trends.

8. The method of claim 1, where that parameters that define the trade instructions include at least one of: execution time, size of the trade order, order type, limit, price, and strategy.

9. The method of claim 1, wherein the market state is defined by a plurality of aspects that affect the state of the market.

10. The method of claim 1, wherein the plurality of aspects of the market includes at least one of: volatility of the market and trading volume.

11. The method of claim 1, wherein the execution strategy includes buying shares of a stock within a specific time interval.

12. A system for executing trade instructions from a user, the system comprising:
a processor; and
memory comprising instructions that when executed by the process causes the processor to:
receive a plurality of input parameters, wherein:
at least one of the plurality of input parameters is associated with market conditions; and
at least one of the plurality of input parameters is associated with parameters that define the trade instructions from the user;
generate one or more matrices, with each of the matrices including a plurality of nodes, wherein each node of the plurality of nodes represents a market state and includes an associated execution strategy based on the market state that each node represents, wherein the market state is defined by a plurality of aspects that affect the state of the market;
using a machine learning model, predict future market conditions;
based on the plurality of input parameters and the future market conditions, define one or more execution signals, wherein each of the one or more execution signals represents an aspect of a predicted market state;
based on the one or more execution signals, select a first node of one of the matrices that represents the predicted market state;
cause the execution of an execution strategy associated with the first node;
receive changes in market conditions as a result of the execution of the execution strategy associated with the first node;
using the machine learning model, predict updated future market conditions;
based on the changes in the market conditions and the updated future market conditions, define one or more updated execution signals such that the one or more updated execution signals represent an aspect of a modified predicted market state;
select a second node that represents the modified predicted market state; and
cause the execution of an updated execution strategy associated with the second node.

13. (canceled)

14. The system of claim 12, wherein the instructions, when executed by the processor, further cause the processor to:
analyze the trade instructions from the user;
determine a plurality of execution phases to the trade instructions, wherein at least two of the plurality of execution phases requires a differing execution strategies; and
generate a matrix stage for each execution phase of the plurality of execution phases.

15. The system of claim 14, wherein to generate one or more matrices includes to generate a matrix with a plurality of nodes for each matrix stage.

16. The system of claim 15, wherein upon completion of one of the plurality of execution phases, switch to the execution of another of the plurality of execution phases.

17. The system of claim 16, wherein the completion of one of the plurality of execution phase includes to:
select a node within a matrix in the matrix stage associated with the execution phase; and
cause the execution of an execution strategy associated with the node.

18. (canceled)

19. The system of claim 12, wherein the plurality of aspects includes at least one of: volatility of the market and trading volume.

20. A computer-implemented method for executing trade instructions from a user, the computer-implemented method being executed on a processor of a computing device and comprising:
receiving a plurality of input parameters, wherein:
at least one of the plurality of input parameters is associated with market conditions; and
at least one of the plurality of input parameters is associated with parameters that define the trade instructions from the user;
analyzing the trade instructions from the user;
determining a plurality of execution phases to the trade instructions including a first execution phase and a second execution phase, wherein each of the plurality of execution phases requires different execution strategies;
generating a matrix stage for each execution phase of the plurality of execution phases, including a first matrix stage associated with the first execution phase and a second matrix stage associated with the second execution phase;
for each matrix stage, generating a matrix with a plurality of nodes, wherein each node of the plurality of nodes represents a market state and includes an associated execution strategy based on the market state that each node represents;
executing the plurality of execution phases, including:
for the first execution phase,
using a machine learning model predicting future market conditions;
based on the plurality of input parameters and the future market condition, defining a first plurality of signals, wherein each of the first plurality of signals represents an aspect of a first predicted market state;
based on the first plurality of signals, selecting a first node of a matrix from the first matrix stage that represents the first predicted market state; and
causing the execution of an execution strategy associated with the first node; and
for the second execution phase,
receiving updated plurality of input parameters, including updated market conditions;
using the machine learning model and based on the predicting updated future market conditions;
based on the updated plurality of input parameters and the updated future market conditions, defining a second plurality of signals, wherein each of the second plurality of signals represents an aspect of a second predicted market state;
based on the second plurality of signals, selecting a second node of a matrix from the second matrix stage that represents the second predicted market state; and
causing the execution of an execution strategy associated with the second node.
